(19) United States
(12) Patent Application Publication
(10) Pub. No.: US 2026/0187554 A1
(43) Pub. Date: Jul. 2, 2026

(54) PLACEMENT SEARCH DEVICE, PLACEMENT SEARCH METHOD AND PLACEMENT SEARCH PROGRAM

(71) Applicant: NTT, Inc., Tokyo (JP)

(72) Inventors: Kenichi FUKUDA, Tokyo (JP); Atsuhiko MAEDA, Tokyo (JP); Yukio KIKUYA, Tokyo (JP); Masato KAMIYA, Tokyo (JP)

(73) Assignee: NTT, Inc., Tokyo (JP)

(21) Appl. No.: 18/857,762

(22) PCT Filed: Apr. 19, 2022
(86) PCT No.: PCT/JP2022/018212

§ 371 Date: Oct. 17, 2024

(51) Int. Cl. G06Q 10/0631; G06Q 10/067; G06Q 50/26

(52) U.S. Cl. CPC G06Q 10/06315; G06Q 10/0674; G06Q 50/265

(57) ABSTRACT

An allocation search device includes a resource data acquisition unit that acquires resource data including a latest resource position and dispatch availability, an allocation plan creation unit that creates a plurality of allocation plans of a resource corresponding to an occurring event, using the resource data, an allocation evaluation unit that assigns an evaluation value to each of the plurality of allocation plans, using the resource data, and an allocation plan selection unit that selects an effective allocation plan from the plurality of allocation plans on the basis of the evaluation value.

### TECHNICAL FIELD

The disclosed technology relates to an allocation search device, an allocation search method, and an allocation search program.

### BACKGROUND ART

There is known a technology of predicting occurrence of an event in each region and optimally allocating a plurality of resources for the event. For example, Non Patent Literature 1 proposes a method of predicting a regional emergency demand and optimally allocating a plurality of emergency squads (ambulances) on the basis of the prediction so that a time required to arrive at a site or a travel distance required to arrive at the site is reduced as much as possible.

### CITATION LIST

### Non Patent Literature

Non Patent Literature 1: “Kyu-kyu big data wo mochiita kyu-kyu jidousha saiteki unyo system no yukosei wo kakunin—realtime na kyu-kyu jyuyo yosoku tou ni yoru kyu-kyu sha no hanso jikan tanshuku wo mezasu—(in Japanese) (Confirmation of effectiveness of emergency vehicle optimal operation system using emergency big data—aiming to reduce ambulance transport time on the basis of real-time emergency demand prediction and the like—)” https://www.ntt.co.jp/news2018/1811/181126a.html

### SUMMARY OF INVENTION

### Technical Problem

For example, it is assumed that occurrence of a sick/injured person per unit time is predicted in each region mesh of 500 m square or 1 km square, and a plurality of emergency squads (ambulances) needs to be appropriately allocated so that the time required to arrive at the site or the travel distance required to arrive at the site is reduced as much as possible. It is assumed that the emergency squads can be allocated in a plurality of fire stations existing in a target region, and an emergency squad waiting at the shortest distance from the site of occurrence of a sick/injured person is dispatched. In this case, since the plurality of emergency squads is to be appropriately allocated in the plurality of fire stations, a discrete optimization problem arises.

However, for example, there are about fifty fire stations and about forty emergency squads in a core city in Japan. In this case, for example, when it is simplified that any number of emergency squads can be allocated in each fire station, the number of allocation patterns is the 40th power of 50 by simple calculation. Therefore, it is difficult to find an optimal solution for such a problem in real time. In addition, as a destination to move, for example, even in a case of considering a continuous space instead of a discrete point such as a fire station, a discrete element of determining which emergency squad is better to be moved from among the plurality of emergency squads occurs and it is desired to determine which emergency squad is to be moved.

Meanwhile, even if occurrence of a sick/injured person is predicted in each regional mesh, a result thereof may be wrong. Regarding this point, it is desirable that emergency squads be in robust allocation that can expect an effect even if the prediction is not completely right.

The disclosed technology has been made in view of the above points, and an object thereof is to provide an allocation search device, an allocation search method, and an allocation search program capable of obtaining robust allocation of resources that can expect an effect even if a prediction result of occurrence of an event is not completely right in a short time during which effective allocation of the resources needs to be determined.

### Solution to Problem

An allocation search device according to one aspect of the present disclosure includes: a resource data acquisition unit configured to acquire resource data including a latest resource position and dispatch availability; an allocation plan creation unit configured to create a plurality of allocation plans of a resource corresponding to an occurring event, using the resource data; an allocation evaluation unit configured to assign an evaluation value to each of the plurality of allocation plans, using the resource data; and an allocation plan selection unit configured to select an effective allocation plan from the plurality of allocation plans on a basis of the evaluation value assigned to each of the plurality of allocation plans.

Further, a sample output unit configured to output, as a main sample, future event occurrence data that is likely to occur under a predetermined condition on a basis of latest event occurrence data may be further included. In this case, the allocation plan creation unit creates the plurality of allocation plans of resources corresponding to an occurring event, using the resource data and the main sample. In a second embodiment to be described below, two modes of (1) dynamic allocation outside fire stations and (2) dynamic allocation in fire stations will be described. In the case of dynamic allocation outside fire stations, an allocation plan is created using the main sample, and in the case of dynamic arrangement in fire stations, an allocation plan is created without using the main sample.

An allocation search method according to one aspect of the present disclosure includes: acquiring resource data including a latest resource position and dispatch availability; creating a plurality of allocation plans of a resource corresponding to an occurring event, using the resource data; assigning an evaluation value to each of the plurality of allocation plans, using the resource data; and selecting an effective allocation plan from the plurality of allocation plans on a basis of the evaluation value assigned to each of the plurality of allocation plans.

An allocation search program according to one aspect of the present disclosure causes a computer to execute: acquiring resource data including a latest resource position and dispatch availability; creating a plurality of allocation plans of a resource corresponding to an occurring event, using the resource data; assigning an evaluation value to each of the plurality of allocation plans, using the resource data; and selecting an effective allocation plan from the plurality of allocation plans on a basis of the evaluation value assigned to each of the plurality of allocation plans.

### Advantageous Effects of Invention

According to the disclosed technology, when there is a demand to shorten an average distance until a resource (for example, an emergency squad) arrives at a site, which resource should be moved and a destination of the resource are calculated in real time, and an allocation plan that is expected to satisfy the demand can be obtained.

### BRIEF DESCRIPTION OF DRAWINGS

FIG. 1 is a block diagram illustrating an example of a hardware configuration of an allocation search device according to a first embodiment.

FIG. 2 is a block diagram illustrating an example of functional configurations of the allocation search device according to the first embodiment.

FIG. 3 is a table illustrating an example of a sick/injured person occurrence data row according to the embodiment.

FIG. 4 is a table illustrating an example of a pseudo occurrence data row according to the embodiment.

FIG. 5 is a table illustrating another example of the pseudo occurrence data row according to the embodiment.

FIG. 6 is a graph illustrating an example of a sick/injured person occurrence probability obtained by MCMC according to the embodiment.

FIG. 7 is a table illustrating an example of ambulance data according to the embodiment.

FIG. 8 is a table illustrating an example of fire station data according to the embodiment.

FIG. 9 is a table illustrating an example of an ambulance allocation plan according to the embodiment.

FIG. 10 is a table illustrating an example of original ambulance allocation according to the embodiment.

FIG. 11 is a table illustrating an example of an effective allocation plan that satisfies evaluation criteria according to the embodiment.

FIG. 12 is a table illustrating an example of an allocation plan that does not satisfy evaluation criteria according to the embodiment.

FIG. 13 is a flowchart illustrating an example of a flow of processing in phase 1 by an allocation search program according to the first embodiment.

FIG. 14 is a flowchart illustrating an example of a flow of evaluation processing according to the first embodiment.

FIG. 15 is a flowchart illustrating an example of a flow of processing in phase 2 by the allocation search program according to the first embodiment.

FIG. 16 is a block diagram illustrating an example of functional configurations of an allocation search device according to a second embodiment.

FIG. 17 is a table illustrating an example of resource data according to the embodiment.

FIG. 18 is a table illustrating an example of a main sample according to the embodiment.

FIG. 19 is a table illustrating an example of fire station data according to the embodiment.

FIG. 20 is a table illustrating an example of correspondence data between an ambulance and a fire station according to the embodiment.

FIG. 21 is a table illustrating an example of a moving vehicle candidate list according to the embodiment.

FIG. 22 is a table illustrating an example of an allocation plan list according to the embodiment.

FIG. 23 is a table illustrating an example of an evaluation result according to the embodiment.

FIG. 24 is a flowchart illustrating an example of a flow of processing by an allocation search program according to the second embodiment.

FIG. 25 is a table illustrating another example of fire station data according to the embodiment.

FIG. 26 is a table illustrating another example of the moving vehicle candidate list according to the embodiment.

### DESCRIPTION OF EMBODIMENTS

The following is a description of an example of embodiments of the technology disclosed herein, with reference to the drawings. In the drawings, the same or equivalent components and portions will be denoted by the same reference signs. Moreover, dimensional ratios in the drawings are exaggerated for convenience of description and thus may be different from actual ratios.

In the present embodiment, there will be described an aspect in which a regional emergency demand is predicted and a plurality of emergency squads (ambulances) is optimally allocated on the basis of the prediction so that a time required to arrive at a site or a travel distance required to arrive at a site is reduced as much as possible. However, the present embodiment can be applied as long as resources can be optimally allocated for an occurring event.

### First Embodiment

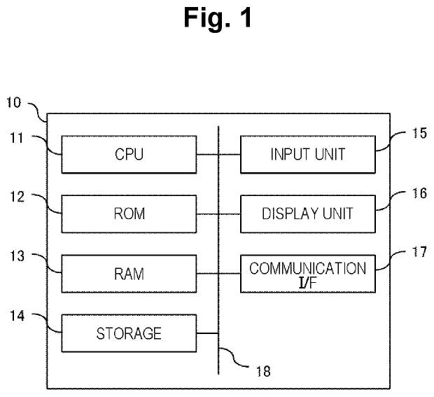

FIG. 1 is a block diagram illustrating an example of a hardware configuration of an allocation search device 10 according to a first embodiment.

As illustrated in FIG. 1, the allocation search device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 18.

The CPU 11 is a central processing unit, which executes various programs and controls each unit. That is, the CPU 11 reads a program from the ROM 12 or the storage 14, and executes the program using the RAM 13 as a working area. The CPU 11 controls the above-described each component and performs various types of operation processing according to the program stored in the ROM 12 or the storage 14. In the present embodiment, the ROM 12 or the storage 14 stores an allocation search program for searching for optimal allocation of resources.

The ROM 12 stores various programs and various types of data. The RAM 13, as a work area, temporarily stores programs or data. The storage 14 includes a hard disk drive (HDD) or a solid state drive (SSD) and stores various programs including an operating system and various types of data.

The input unit 15 includes a pointing device such as a mouse and a keyboard and is used to perform various inputs to the local device.

The display unit 16 is, for example, a liquid crystal display and displays various types of information. The display unit 16 may function as the input unit 15 by employing a touchscreen system.

The communication interface 17 is an interface through which the local device communicates with another external device. The communication is performed in conformity to, for example, a wired communication standard such as Ethernet (registered trademark) or fiber distributed data interface (FDDI) or a wireless communication standard such as 4G, 5G, or Wi-Fi (registered trademark).

For example, a general-purpose computer device such as a server computer or personal computer (PC) is applied to the allocation search device 10 according to the present embodiment.

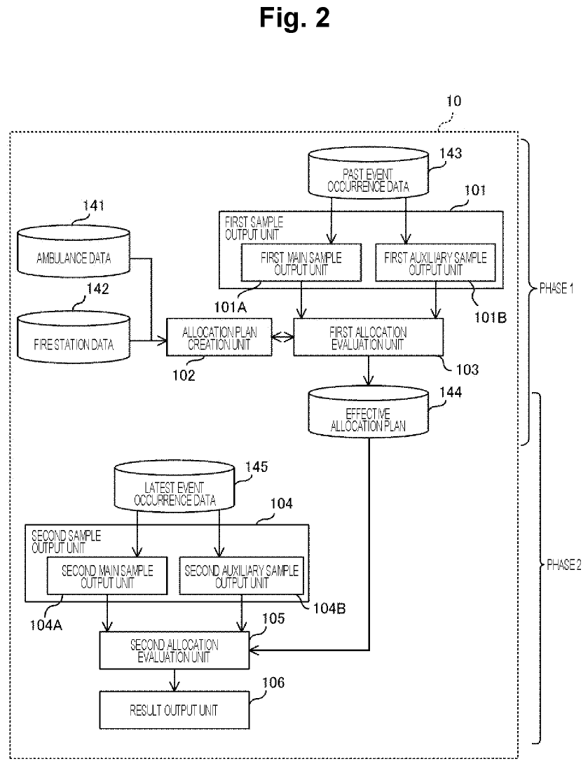

Next, a functional configuration of the allocation search device 10 according to the first embodiment will be described with reference to FIG. 2.

FIG. 2 is a block diagram illustrating an example of functional configurations of the allocation search device 10 according to the first embodiment.

As illustrated in FIG. 2, the allocation search device 10 includes, as the functional configurations, a first sample output unit 101, an allocation plan creation unit 102, a first allocation evaluation unit 103, a second sample output unit 104, a second allocation evaluation unit 105, and a result output unit 106. Each functional configuration is achieved by the CPU 11 reading the allocation search program stored in the ROM 12 or the storage 14, developing the allocation search program in the RAM 13, and executing the allocation search program.

The first sample output unit 101 includes a first main sample output unit 101A and a first auxiliary sample output unit 101B, and the second sample output unit 104 includes a second main sample output unit 104A and a second auxiliary sample output unit 104B.

The storage 14 stores ambulance data 141, fire station data 142, past event occurrence data 143, an effective allocation plan 144, and latest event occurrence data 145. The ambulance data 141, the fire station data 142, the past event occurrence data 143, the effective allocation plan 144, and the latest event occurrence data 145 may be stored in an external storage device.

The past event occurrence data 143 is a data row of event occurrence data obtained in the past. The past referred to herein means a certain period in the past from a current point of time at which allocation search is performed and is, for example, a period of past several months or past several years. The latest event occurrence data 145 is a data row of the latest event occurrence data. The latest referred to herein means a certain period immediately before the current point of time at which allocation search is performed and is, for example, a period of the last several days or the last several months. That is, the latest period is shorter than the past period. The event occurrence data is, for example, sick/injured person occurrence data (i.e., data indicating the year, month, date, day, hour, minute, longitude, and latitude at which a sick/injured person has occurred).

The first sample output unit 101 outputs event occurrence data that is likely to occur under a predetermined condition as a first main sample and outputs event occurrence data that is likely to occur under a condition similar to the predetermined condition as a first auxiliary sample, on the basis of the past event occurrence data 143. The predetermined condition is, for example, a condition such as 10:00 on weekdays in September, and the condition similar to the condition is, for example, a condition such as 10:00 on weekdays in August and October. In the present embodiment, the first main sample output unit 101A outputs the first main sample, and the first auxiliary sample output unit 101B outputs the first auxiliary sample.

The first main sample may be expressed as, for example, a pseudo occurrence data row generated in a pseudo manner in accordance with an event occurrence frequency that is obtained in each certain area on the basis of a data row that has actually occurred under the predetermined condition. Similarly, the first auxiliary sample may be expressed as, for example, a pseudo occurrence data row generated in a pseudo manner in accordance with an event occurrence frequency that is obtained in each certain area on the basis of a data row that has actually occurred under the condition similar to the predetermined condition. The first main sample may also be expressed as a pseudo occurrence data row generated in a pseudo manner in accordance with a random variable of an event occurrence probability that is obtained on the basis of the data row that has actually occurred under the predetermined condition. Similarly, the first auxiliary sample may also be expressed as a pseudo occurrence data row generated in a pseudo manner in accordance with a random variable of an event occurrence probability that is obtained on the basis of the data row that has actually occurred under the condition similar to the predetermined condition. Specific examples of the event occurrence frequency and the event occurrence probability will be described later.

The allocation plan creation unit 102 creates a plurality of allocation plans of resources for an occurring event. In the present embodiment, the allocation plan creation unit 102 creates a plurality of allocation plans of ambulances for allocating the ambulances to fire stations by using the ambulance data 141 and the fire station data 142.

The first allocation evaluation unit 103 uses the first main sample, the first auxiliary sample, and the plurality of allocation plans as inputs and evaluates whether each of the plurality of allocation plans satisfies a predetermined evaluation criterion in a case where the first main sample and the first auxiliary sample are applied to each of the plurality of allocation plans. The first allocation evaluation unit 103 stores an allocation plan that satisfies the predetermined evaluation criterion in the storage 14 as the effective allocation plan 144. The processing so far is “phase 1”.

Next, based on the latest event occurrence data 145, the second sample output unit 104 outputs future event occurrence data that is likely to occur under a predetermined condition as a second main sample and outputs future event occurrence data that is likely to occur under a condition similar to the predetermined condition as a second auxiliary sample. Both the predetermined condition and the condition similar to the predetermined condition are the same as the conditions in the first sample output unit 101. In the present embodiment, the second main sample output unit 104A outputs the second main sample, and the second auxiliary sample output unit 104B outputs the second auxiliary sample.

The second allocation evaluation unit 105 uses the second main sample, the second auxiliary sample, and the effective allocation plan 144 as inputs and reevaluates whether each effective allocation plan 144 satisfies a predetermined evaluation criterion in a case where the second main sample and the second auxiliary sample are applied to each effective allocation plan 144.

As a result of the reevaluation by the second allocation evaluation unit 105, the result output unit 106 outputs an effective allocation plan that satisfies the predetermined evaluation criterion as optimal allocation of the resources. The processing so far is “phase 2”.

The present embodiment roughly includes two implementation phases, i.e., phase 1 and phase 2, as described above. Phase 1 is a phase in which a large number of allocation patterns in effective ambulance allocation plans are found in advance on the basis of past sick/injured person occurrence data. Phase 1 is performed, for example, at the beginning of the year, every quarter, or once a month. Phase 2 is a phase in which, for example, occurrence of a sick/injured person in near future is predicted on the basis of the latest sick/injured person occurrence data at the same time every day, the most effective allocation pattern is found from the effective allocation patterns found in advance in phase 1, and allocation is changed according to the most effective allocation pattern.

First, the processing in phase 1 will be described by exemplifying a case where, for example, optimal allocation of ambulances between 10:00 and 11:00 on weekdays in the next month of September is obtained in August. The first main sample output unit 101A outputs a plurality of occurrence data rows predicted to be most likely to occur under a predetermined condition (e.g. between 10:00 and 11:00 on weekdays in September) as the first main sample on the basis of the past sick/injured person occurrence data accumulated by August. Further, the first auxiliary sample output unit 101B outputs a plurality of occurrence data rows predicted to be likely to occur under a condition (e.g. between 10:00 and 11:00 on weekdays in August and October) similar to the predetermined condition as the first auxiliary sample on the basis of the past sick/injured person occurrence data accumulated by August.

There is a plurality of methods of outputting the first main sample and the first auxiliary sample. A first method, which is the simplest method, is to output actual occurrence data rows between 10:00 and 11:00 on weekdays in September for the past several years as they are as the first main sample and output actual occurrence data rows between 10:00 and 11:00 on weekdays in August and in October for the past several years as the first auxiliary sample. The samples are processed as described above on the following two assumptions: similar sick/injured person occurrence patterns occur in the same month, the same day, and the same time slot every year; and the occurrence data rows in August and in October are similar to the occurrence data rows in September because, for example, average daily temperatures in August and October are relatively close to that in September.

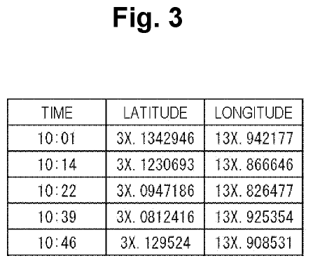

FIG. 3 illustrates an example of the sick/injured person occurrence data rows according to the present embodiment.

The sick/injured person occurrence data rows in FIG. 3 are an example of occurrence data rows for a period of time between 10:00 and 11:00 on one weekday, which are output as the first main sample by the first main sample output unit 101A by the above method. In the example of FIG. 3, information regarding the year, month, date, and day is not output because the information is unnecessary for the subsequent processing. Data only for one day is output in the example of FIG. 3, but, in practice, data for a plurality of days (e.g. 100 days if the corresponding number of days is 100 days) is output. The same similarly applies to the sick/injured person occurrence data rows output as the first auxiliary sample by the first auxiliary sample output unit 101B. In this method, the number of days output from the first auxiliary sample output unit 101B is generally larger than the number of days output from the first main sample output unit 101A.

As a second method, which is another simple method, actual occurrence data rows between 10:00 and 11:00 on weekdays in September for the past several years may be output as they are as the first main sample, and actual occurrence data rows between 10:00 and 11:00 on weekdays from January to December including a period of time between 10:00 and 11:00 on weekdays in September for the past several years may be output as the first auxiliary sample.

As a third method, which is still another method, a method of creating and using pseudo occurrence data rows will be described. Specifically, the first main sample output unit 101A obtains a sick/injured person occurrence frequency in a certain area (e.g. every 500 m square or every 1 km square) on the basis of the actual occurrence data rows between 10:00 and 11:00 on weekdays in September for the past several years and generates occurrence data rows in a pseudo manner in accordance with the frequency. The sick/injured person occurrence frequency is an example of the event occurrence frequency. For example, the sick/injured person occurrence frequency in a certain area of 500 m square between 10:00 and 11:00 on weekdays in September is obtained as 30/100=0.3, where the past occurrence data rows to be used are, for example, data for 100 days and the total number of occurrence of sick/injured person during the period is, for example, 30 persons. Similarly, the occurrence frequency may be obtained in all areas of a target region, pseudo occurrence data rows corresponding to values of the occurrence frequencies may be generated, and the data rows in all the areas may be used as one set. Regarding at which position in the target area a sick/injured person occurs, a sick/injured person may occur on the basis of, for example, a density obtained by kernel density estimation that is performed by plotting past actual occurrence positions. An advantage of the method of creating pseudo occurrence data rows is that robust verification using more occurrence patterns can be performed by creating more samples than occurrence data rows that have actually occurred in the past.

At this time, the first auxiliary sample output unit 101B may increase or decrease 0.3 that is a value of the occurrence frequency calculated as described above by a certain value (e.g. increase or decrease 0.3 by 0.05 every time, thereby obtaining values of 0.35 and 0.25) and generate pseudo occurrence data rows on the basis of the values. Alternatively, as in the above example, the occurrence frequency may be generated on the basis of the past occurrence data rows in August and in October and then pseudo occurrence data rows may be generated.

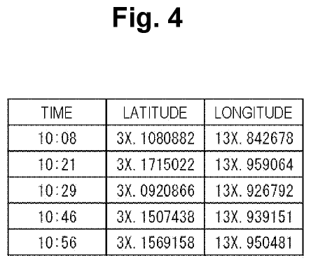

FIG. 4 illustrates an example of the pseudo occurrence data rows according to the present embodiment.

The pseudo occurrence data rows in FIG. 4 are obtained by obtaining an occurrence frequency in each area, generating pseudo occurrence data, and summarizing the pseudo occurrence data as one set of data rows. The occurrence frequency is the same as that in the above example of FIG. 3.

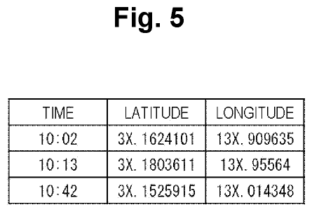

FIG. 5 illustrates another example of the pseudo occurrence data rows according to the present embodiment.

The pseudo occurrence data rows in FIG. 5 are created after an occurrence frequency is obtained in each area and then the occurrence frequency in each area is decreased by a certain value. As a result, the total number of occurrences between 10:00 and 11:00 is smaller than that in the example of FIG. 4.

As a fourth method, which is further another method, a method of obtaining a sick/injured person occurrence probability as a random variable and creating pseudo occurrence data will be described. The sick/injured person occurrence probability is an example of the event occurrence probability. Obtaining the sick/injured person occurrence probability as the random variable means that a possibility that the sick/injured person occurrence probability takes various values is considered, for example, a possibility that 0.3 persons occur is 50%, a possibility that 0.31 persons occur is 10%, a possibility that 0.32 persons occur is 5%, . . . , and each possibility is expressed as a probability. To obtain the sick/injured person occurrence probability as the random variable, target past occurrence data rows may be assumed to occur according to the Poisson distribution, and a parameter of the Poisson distribution (indicating how many times a sick/injured person occurs within a certain period of time) may be obtained as the random variable by using the Markov chain Monte Carlo method (MCMC) or the like. From this result, the first main sample output unit 101A may generate pseudo occurrence data on the basis of a parameter having the highest probability, and the first auxiliary sample output unit 101B may generate pseudo occurrence data on the basis of parameters having other probabilities. In practice, the occurrence probability has a continuous distribution, and thus the pseudo occurrence data may be generated by picking up parameters at certain intervals from the distribution.

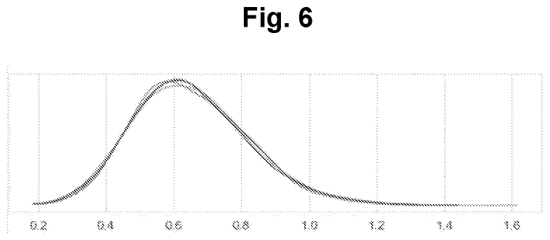

FIG. 6 is graphs illustrating an example of the sick/injured person occurrence probability obtained by MCMC according to the present embodiment.

The graphs in FIG. 6 visualize a result of obtaining the parameters of the Poisson distribution as the random variables as described above. The horizontal axis represents the value of the parameter of the Poisson distribution, and the vertical axis represents the probability thereof. There are four graphs in the example of FIG. 6, and each graph corresponds to a chain of MCMC. This indicates that the graphs are calculated by using four chains. The four graphs are approximately overlapped. This indicates that the calculation of MCMC is approximately convergent. In this case, the first main sample output unit 101A generates occurrence data in a pseudo manner in accordance with the Poisson distribution of the parameter of 0.6 that is the highest probability. Meanwhile, the first auxiliary sample output unit 101B generates occurrence data on the basis of, for example, the parameters 0.2, 0.4, 0.8, and 1.0 around 0.6.

In a case where both the first main sample output unit 101A and the first auxiliary sample output unit 101B generate pseudo occurrence data rows, the number of days for the first auxiliary sample output unit 101B may be intentionally reduced. Note that it is not the matter of the length of the data rows. The length of the data rows increases as the parameter of the occurrence probability increases. In a case where the parameter of the Poisson distribution is obtained as the random variable by MCMC described above, the number of days of data generation may be determined according to the magnitude of the probability. In the example of FIG. 6 described above, the number of samples is reduced in the order of the parameters 0.6, 0.8, 0.4, 1.0, and 0.2. The first allocation evaluation unit 103 in the subsequent stage basically performs evaluation while putting a weight on the data rows output by the first main sample output unit 101A. However, in a case where the number of days of data rows output by the first auxiliary sample output unit 101B is intentionally reduced to be smaller than the number of days output by the first main sample output unit 101A, the processing is equivalent processing even when an evaluation is performed with a weighted average on the basis of a unified evaluation criterion.

The occurrence data rows created by the first main sample output unit 101A and the first auxiliary sample output unit 101B are output to the first allocation evaluation unit 103.

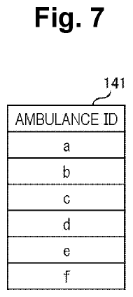

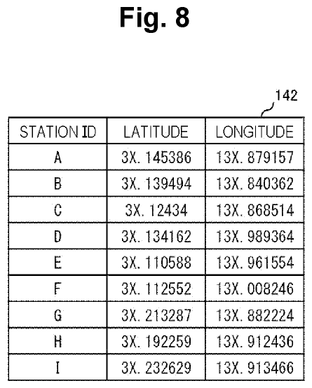

Meanwhile, the allocation plan creation unit 102 creates, for example, a plurality of allocation plans for allocating ambulances to fire stations on the basis of the ambulance data 141 in FIG. 7 and the fire station data 142 in FIG. 8.

FIG. 7 illustrates an example of the ambulance data 141 according to the present embodiment. FIG. 8 illustrates an example of the fire station data 142 according to the present embodiment.

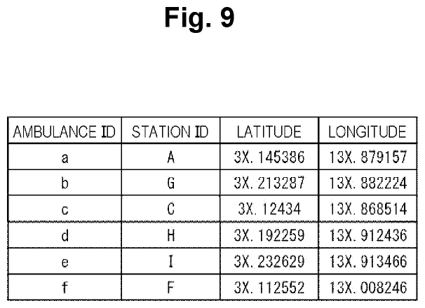

In the example of the ambulance data 141 in FIG. 7, six ambulances having ambulance identifications (IDs) a to f are registered. In the example of the fire station data 142 in FIG. 8, nine fire stations having fire station IDs A to I are registered. As a method of creating a first allocation plan, for example, allocation plans may be randomly created as illustrated in FIG. 9.

FIG. 9 illustrates an example of ambulance allocation plans according to the present embodiment. Unique IDs (not illustrated) are assigned to the plurality of allocation plans created by the allocation plan creation unit 102.

The allocation plans created by the allocation plan creation unit 102 are output to the first allocation evaluation unit 103. There are various methods of creating the second and subsequent allocation plans. The simplest method is a method of also randomly creating the second and subsequent allocation plans. However, in this case, in a case where the number of combinations is enormous, a long time may be required until an allocation plan evaluated to be effective by the first allocation evaluation unit 103 is specified. In view of this, various heuristics (also referred to as heuristic methods) can be used. One of the methods is a method using a genetic algorithm.

An example of the method using a genetic algorithm will be described. An allocation plan is randomly created until an allocation plan evaluated to be effective by the first allocation evaluation unit 103 is specified, and, in a case where an allocation plan is evaluated to be effective, a next allocation plan is created by randomly changing a part of the allocation plan on the basis of the allocation plan or combining a plurality of allocation plans evaluated to be effective. Combining the plurality of allocation plans means that, for example, allocation of the ambulances a to c is extracted from one allocation plan, allocation of the ambulances d to f is extracted from another allocation plan, and the allocations are combined. In this way, it is empirically known that a solution close to an optimal solution can be obtained in a relatively short time.

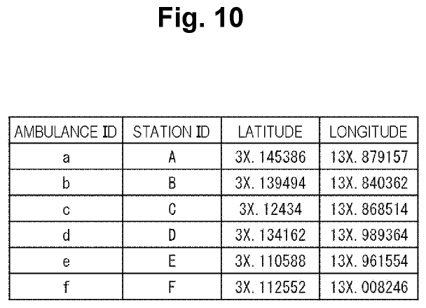

Next, the first allocation evaluation unit 103 evaluates the allocation plans acquired from the allocation plan creation unit 102 by using the occurrence data rows acquired from both the first main sample output unit 101A and the first auxiliary sample output unit 101B. As an evaluation method, for example, an average of distances that a dispatchable ambulance existing closest to a site of occurrence of a sick/injured person travels until the ambulance arrives at the site is calculated, and the calculated average travel distance is compared with, for example, an average travel distance in original ambulance allocation in FIG. 10.

FIG. 10 illustrates an example of the original ambulance allocation according to the present embodiment.

In a case where a certain ambulance is dispatched, the certain ambulance cannot respond to the next request for dispatch for a certain period of time. The certain period of time may be, for example, a value of an average time required to complete transport of a sick/injured person and obtained in advance. For example, in a case where the average time required to complete transport of a sick/injured person is 50 minutes, the certain ambulance cannot respond to the next request for dispatch for 50 minutes. As a method of obtaining a distance to a site of occurrence of a sick/injured person, for example, a direct distance may be used most simply, or the shortest distance on a road network may be used in a case where road network data can be prepared.

In a case where the first main sample output unit 101A outputs data for 100 days, for example, the first allocation evaluation unit 103 evaluates all the data for 100 days. The same similarly applies to the data output from the first auxiliary sample output unit 101B.

As initial values of states of the ambulances, in practice, there is a possibility that several ambulances have already been dispatched. Therefore, for example, it is desirable to perform evaluation in various initial states for each sample for one day. The initial states are, for example, a state in which the ambulance a is currently dispatched and returns in 30 minutes, a state in which the ambulances a and b are currently dispatched, and the ambulance a can respond in 30 minutes and the ambulance b can respond in 40 minutes, and the like.

As a result of the evaluation described above, in a case where an allocation plan satisfies the predetermined evaluation criterion, the allocation plan is regarded to be effective and is stored in the storage 14 as the effective allocation plan 144.

At this time, basically, the occurrence data rows acquired from the first main sample output unit 101A and the occurrence data rows acquired from the first auxiliary sample output unit 101B have different importance and therefore may be evaluated on the basis of different evaluation criteria. For example, in the occurrence data rows acquired from the first main sample output unit 101A, the allocation plan satisfies the evaluation criterion in a case where an average distance required to arrive at a site (hereinafter, referred to as a “site arrival distance”) is shortened from an average distance in original allocation serving as a reference by 100 m or more on average. Meanwhile, in the occurrence data rows acquired from the first auxiliary sample output unit 101B, the allocation plan satisfies the evaluation criterion in a case where the average site arrival distance is shortened by 50 m or more.

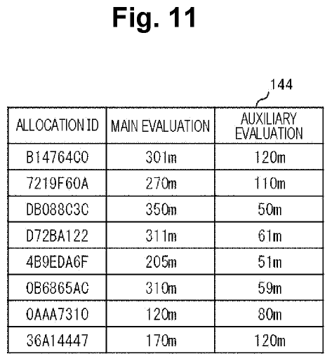

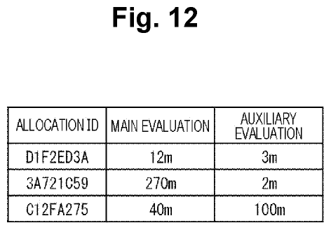

FIG. 11 illustrates an example of the effective allocation plan 144 that satisfies the evaluation criteria according to the present embodiment. FIG. 12 illustrates an example of an allocation plan that does not satisfy the evaluation criteria according to the present embodiment.

In the effective allocation plan 144 in FIG. 11, the main evaluation and the auxiliary evaluation are associated with an allocation ID indicating an allocation plan. The main evaluation indicates a distance difference obtained in a case where the occurrence data rows acquired from the first main sample output unit 101A are applied to the allocation plan, and the auxiliary evaluation indicates a distance difference obtained in a case where the occurrence data rows acquired from the first auxiliary sample output unit 101B are applied to the allocation plan. The distance difference referred to herein indicates, as described above, a difference between the average site arrival distance obtained in a case where the occurrence data rows are applied to the allocation plan and the average site arrival distance obtained in a case where the occurrence data rows are applied to the original allocation. The evaluation criteria are different criteria between the main evaluation and the auxiliary evaluation as described above (e.g. the shortened distance difference is 100 m or more on average in the main evaluation, and the shortened distance difference is 50 m or more on average in the auxiliary evaluation). That is, the effective allocation plan 144 in FIG. 11 satisfies the evaluation criteria in both the main evaluation and the auxiliary evaluation.

Meanwhile, the allocation plan in FIG. 12 does not satisfy the evaluation criteria. For example, an allocation plan having an allocation ID of D1F2ED3A does not satisfy the evaluation criteria in both the main evaluation and the auxiliary evaluation. An allocation plan having an allocation ID of 3A721C59 satisfies the evaluation criterion in the main evaluation, but does not satisfy the evaluation criterion in the auxiliary evaluation. On the contrary, an allocation plan having an allocation ID of C12FA275 does not satisfy the evaluation criterion in the main evaluation, but satisfies the evaluation criterion in the auxiliary evaluation.

In a case where the number of days in the occurrence data rows output by the first auxiliary sample output unit 101B is intentionally reduced to be smaller than the number of days output by the first main sample output unit 101A as described above, evaluation may be performed with a weighted average on the basis of a unified evaluation criterion.

The first allocation evaluation unit 103 may output an evaluation result of a certain allocation plan to the allocation plan creation unit 102 and reflect the evaluation result in creation of the next allocation plan.

As described above, it is possible to empirically find several tens to several hundreds of effective allocation patterns by repeating the above processing in phase 1 for more than ten hours by using a general-purpose PC or the like.

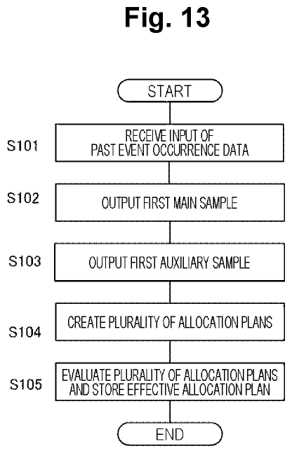

Next, an operation of the allocation search device 10 according to the first embodiment will be described with reference to FIG. 13.

FIG. 13 is a flowchart illustrating an example of a flow of processing in phase 1 by an allocation search program according to the first embodiment. The processing in phase 1 by the allocation search program is implemented by the CPU 11 of the allocation search device 10 writing the allocation search program stored in the ROM 12 or the storage 14 to the RAM 13 and executing the allocation search program.

In step S101 of FIG. 13, the CPU 11 receives input of the past event occurrence data 143 indicating, for example, event occurrence data for the past several years. In this example, the event occurrence data indicates, for example, the sick/injured person occurrence data as described above.

In step S102, the CPU 11 outputs event occurrence data that is likely to occur under a predetermined condition as a first main sample on the basis of the past event occurrence data 143 received as the input in step S101. In this example, the predetermined condition is that, for example, a period of time between 10:00 and 11:00 on weekdays in September as described above.

In step S103, the CPU 11 outputs event occurrence data that is likely to occur under a condition similar to the above predetermined condition as a first auxiliary sample on the basis of the past event occurrence data 143 received as the input in step S101. In this example, the similar condition indicates, for example, a condition such as a period of time between 10:00 and 11:00 on weekdays in August and October before and after September as described above. Further, since the first auxiliary sample is not essential, step S103 may be skipped in a case where the first auxiliary sample is not used.

In step S104, for example, the CPU 11 creates a plurality of allocation plans of ambulances for a sick/injured person occurrence event on the basis of the above ambulance data 141 in FIG. 7 and the above fire station data 142 in FIG. 8.

In step S105, the CPU 11 applies the first main sample output in step S102 and the first auxiliary sample output in step S103 to each of the plurality of allocation plans created in step S104 and evaluates whether each of the plurality of allocation plans satisfies the evaluation criteria. Then, among the plurality of allocation plans, the CPU 11 stores effective allocation plans that satisfy the evaluation criteria in the storage 14 as, for example, the above effective allocation plans 144 in FIG. 11, and the processing in phase 1 by the allocation search program ends.

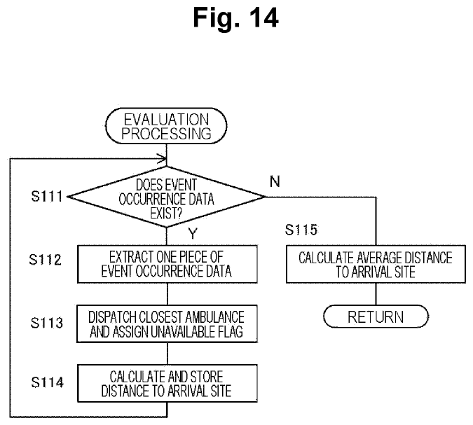

FIG. 14 is a flowchart illustrating an example of a flow of evaluation processing according to the first embodiment. The flow of FIG. 14 specifically illustrates the evaluation processing in step S105 of FIG. 13.

In step S111 of FIG. 14, the CPU 11 determines whether event occurrence data indicating the first main sample or the first auxiliary sample exists. When it is determined that the event occurrence data exists (in a case of positive determination), the processing proceeds to step S112, and, when it is determined that the event occurrence data does not exist (in a case of negative determination), the processing proceeds to step S115.

In step S112, the CPU 11 extracts one piece of the event occurrence data.

In step S113, the CPU 11 dispatches the closest ambulance for the event occurrence data extracted in step S112 and assigns, to the dispatched ambulance, a dispatch unavailable flag indicating that the dispatched ambulance cannot be allowed for the next dispatch for a certain period of time.

In step S114, the CPU 11 calculates a distance from a fire station where the ambulance to which the dispatch unavailable flag is assigned in step S113 is allocated to a site at which the ambulance arrives, stores the calculated distance in the storage 14, returns to step S111, and repeats the processing for all pieces of the event occurrence data.

Meanwhile, in step S115, the CPU 11 calculates an average distance required to arrive at the site, and returns to step S105 in FIG. 13. As an evaluation method, as described above, an average of distances that dispatchable ambulances existing closest to a site of occurrence of a sick/injured person travel until the ambulances arrive at the site is calculated, and the calculated average travel distance is compared with, for example, an average travel distance in the above original ambulance allocation in FIG. 10.

Next, processing in phase 2 will be described. The processing in phase 2 is executed, for example, at a fixed time before 10:00 (e.g. 9:00) on weekdays in September. The second sample output unit 104 obtains, for example, an occurrence frequency of a sick/injured person in each area between 10:00 and 11:00 on weekdays in the last month on the basis of the latest event occurrence data 145 and samples future pseudo occurrence data on the basis of a result thereof. The latest event occurrence data 145 indicates the latest past sick/injured person occurrence data accumulated by immediately before. The number of days to be sampled is, for example, 100 days. In addition, as in the processing in phase 1 described above, the second main sample output unit 104A and the second auxiliary sample output unit 104B may share roles, increase or decrease the occurrence frequency by a certain value, and output samples, or may generate samples on the basis of the random variable by using MCMC described above in FIG. 6.

The second allocation evaluation unit 105 evaluates all the effective allocation plans 144 accumulated in the storage 14. The evaluation method herein is similar to the evaluation method in the processing in phase 1 described above, except that the acquired allocation plans are not the allocation plans created by the allocation plan creation unit 102, but are the effective allocation plans 144 evaluated by the first allocation evaluation unit 103.

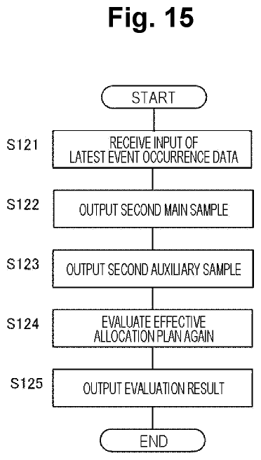

FIG. 15 is a flowchart illustrating an example of a flow of processing in phase 2 by the allocation search program according to the first embodiment. The processing in phase 2 by the allocation search program is implemented by the CPU 11 of the allocation search device 10 writing the allocation search program stored in the ROM 12 or the storage 14 to the RAM 13 and executing the allocation search program.

In step S121 of FIG. 15, the CPU 11 receives input of the latest event occurrence data 145 indicating, for example, event occurrence data in the last month. In this example, the event occurrence data indicates, for example, the sick/injured person occurrence data as in phase 1 described above.

In step S122, the CPU 11 outputs future event occurrence data that is likely to occur under a predetermined condition as a second main sample on the basis of the latest event occurrence data 145 received as the input in step S121. In this example, the predetermined condition indicates, for example, a condition such as a period of time between 10:00 and 11:00 on weekdays in September as in phase 1 described above.

In step S123, the CPU 11 outputs future event occurrence data that is likely to occur under a condition similar to the above predetermined condition as a second auxiliary sample on the basis of the latest event occurrence data 145 received as the input in step S121. In this example, the similar condition indicates, for example, a condition such as a period of time between 10:00 and 11:00 on weekdays in August and October before and after September as in phase 1 described above. Further, since the second auxiliary sample is not essential, step S123 may be skipped in a case where the second auxiliary sample is not used.

In step S124, the CPU 11 applies the second main sample output in step S122 and the second auxiliary sample output in step S123 to each of the effective allocation plans 144 (see FIG. 11) stored in the storage 14 in phase 1 described above and reevaluates whether each effective allocation plan 144 satisfies the evaluation criteria. The reevaluation method is similar to the evaluation method in phase 1 described above.

In step S125, the CPU 11 outputs a final evaluation result obtained by the reevaluation in step S124, and the processing in phase 2 by the allocation search program ends.

In this way, the effective allocation plans are evaluated again on the basis of the latest occurrence data rows. As a result, an evaluation result may be different from the above evaluation result in FIG. 11. A user can decide which allocation of resources is finally employed on the basis of the evaluation result.

The processing in phase 2 can be performed by a general-purpose PC in about several tens of seconds to several minutes. Therefore, for example, it is possible to quickly find and employ appropriate allocation of the resources on the basis of the latest event occurrence data on the day when the allocation of the resources is desired to be changed.

The above method can be applied to other cases. For example, in case that the number of emergency squads is reduced for some reason, it is also possible to obtain effective allocation with a small number of emergency squads in advance and use the allocation.

As described above, according to the present embodiment, it is possible to obtain robust allocation of resources that can expect an effect even if a prediction result of occurrence of an event is not completely right in a case where effective allocation of the resources needs to be determined in a relatively short time.

### Second Embodiment

In a second embodiment, a mode of calculating a destination of a resource (for example, an ambulance) in real time using latest data will be described.

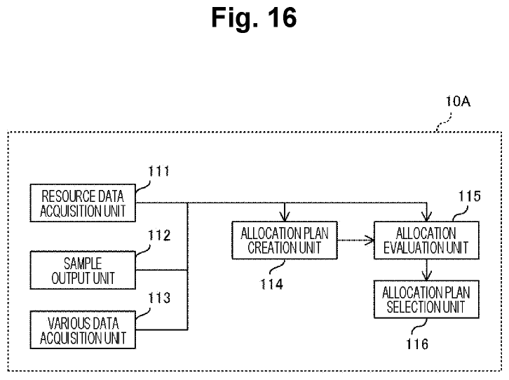

Next, a functional configuration of an allocation search device 10A according to the second embodiment will be described with reference to FIG. 16. Hereinafter, the above-described (1) dynamic allocation outside fire stations, that is, a mode of creating an allocation plan using a main sample will be described.

FIG. 16 is a block diagram illustrating an example of functional configurations of the allocation search device 10A according to the second embodiment.

As illustrated in FIG. 16, the allocation search device 10A includes, as the functional configurations, a resource data acquisition unit 111, a sample output unit 112, a various data acquisition unit 113, an allocation plan creation unit 114, an allocation evaluation unit 115, and an allocation plan selection unit 116. Each functional configuration is achieved by a CPU 11 reading an allocation search program stored in a ROM 12 or a storage 14, developing the allocation search program in a RAM 13, and executing the allocation search program.

The resource data acquisition unit 111 acquires resource data including latest resource position and dispatch availability. The resource data is, for example, latest data related to ambulances (vehicles), and is acquired from ambulance data 141.

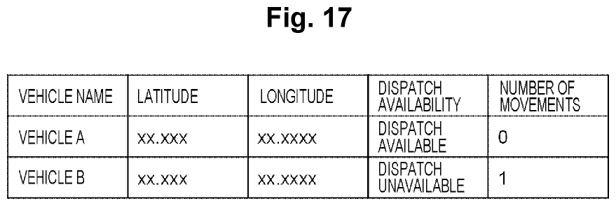

FIG. 17 is a table illustrating an example of the resource data according to the present embodiment.

The resource data illustrated in FIG. 17 includes a vehicle name, latitude and longitude indicating a current position, dispatch availability indicating whether a dispatch is possible, and the number of movements indicating the number of times of movement, regarding an ambulance. The resource data is updated at regular time intervals or every time there is a change in the data.

The sample output unit 112 outputs future event occurrence data that is likely to occur under a predetermined condition as a main sample on the basis of the latest event occurrence data. Note that the latest event occurrence data is acquired from latest event occurrence data 145. The main sample is expressed as, as described above, a pseudo occurrence data row generated in a pseudo manner in accordance with an event occurrence frequency that is obtained in each certain area on the basis of a data row that has actually occurred under the predetermined condition. The main sample may also be expressed as a pseudo occurrence data row generated in a pseudo manner in accordance with a random variable of an event occurrence probability that is obtained on the basis of the data row that has actually occurred under the predetermined condition.

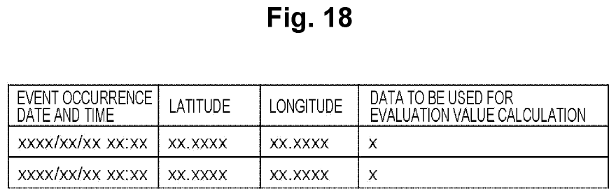

FIG. 18 is a table illustrating an example of the main sample according to the present embodiment.

The main sample illustrated in FIG. 18 is data in which an event that is likely to occur is predicted, and includes event occurrence date and time, the latitude and longitude representing a place of event occurrence, and data to be used for evaluation value calculation. Note that the “data to be used for evaluation value calculation” represents, for example, a time taken from dispatch to return.

The various data acquisition unit 113 acquires fire station data related to fire stations and correspondence data between an ambulance and a fire station. The fire station data is acquired from the fire station data 142, and the correspondence data between an ambulance and a fire station is acquired from the ambulance data 141 or the fire station data 142.

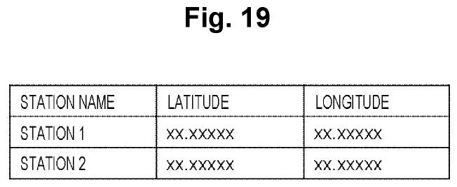

FIG. 19 is a table illustrating an example of the fire station data according to the present embodiment.

The fire station data illustrated in FIG. 19 includes a station name, and latitude and longitude representing a place, regarding a fire station.

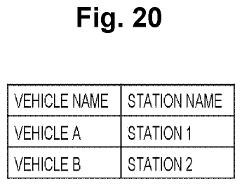

FIG. 20 is a table illustrating an example of correspondence data between an ambulance and a fire station according to the present embodiment.

In the correspondence data between an ambulance and a fire station illustrated in FIG. 20, the vehicle name of the ambulance and the station name of the fire station are associated with each other.

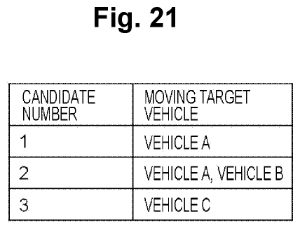

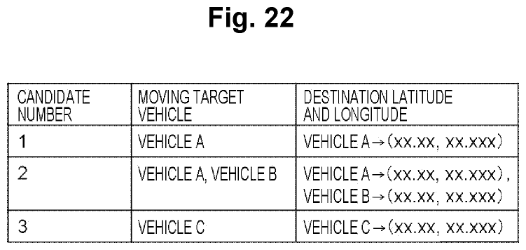

The allocation plan creation unit 114 creates a plurality of allocation plans of resources corresponding to an event occurring in real time using the above-described various data illustrated in FIGS. 17 to 20. An example of a procedure for creating an allocation plan will be described with reference to FIGS. 21 and 22.

FIG. 21 is a table illustrating an example of a moving vehicle candidate list according to the present embodiment.

In the moving vehicle candidate list illustrated in FIG. 21, one vehicle may be designated or a plurality of vehicles may be designated as a moving target vehicle. Furthermore, it is assumed that resource data obtained in real time is reflected, for example, the moving target vehicle is limited to vehicles that are dispatchable and stand by at the fire stations, limited to vehicles whose number of movements is equal to or less than a threshold, or the like.

Next, the destination of each moving vehicle candidate registered in the moving vehicle candidate list illustrated in FIG. 21 is calculated using an arbitrary calculation method, and as an example, an allocation plan list illustrated in FIG. 22 is created. Note that the destination referred to here is not limited to a fire station, and includes any point other than a fire station.

FIG. 22 is a table illustrating an example of the allocation plan list according to the present embodiment.

The allocation plan list illustrated in FIG. 22 is represented as a list in which the latitude and longitude of the destination are assigned to each moving vehicle candidate in the moving vehicle candidate list.

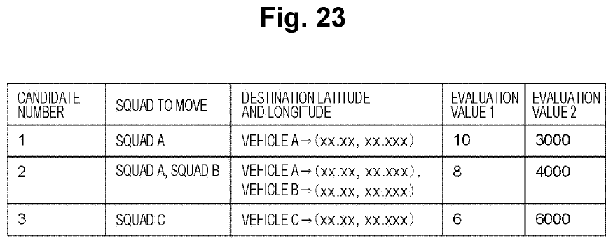

When the main sample is applied to each of the plurality of allocation plans, the allocation evaluation unit 115 assigns the evaluation value to each of the plurality of allocation plans using the resource data. Specifically, the evaluation value is assigned to each allocation plan in the allocation plan list illustrated in FIG. 22 above, and as an example, an evaluation result illustrated in FIG. 23 is obtained.

FIG. 23 is a table illustrating an example of the evaluation result according to the present embodiment.

Here, as a method of calculating the evaluation value, for example, there is a method of reflecting the current position information and dispatch availability information of each vehicle obtained from the resource data illustrated in FIG. 17 and performing a simulation for each moving vehicle candidate in a case of moving the moving target vehicle to the latitude and longitude of the destination. When an average on-site arrival distance is calculated by this simulation, the calculated average site arrival distance can be used as the evaluation value. Furthermore, in the simulation, the above “data to be used for evaluation value calculation” of the main sample illustrated in FIG. 18 can be used. As the “data to be used for evaluation value calculation”, data corresponding to content of simulation to be performed may be acquired.

The above simulation will be specifically described. The allocation evaluation unit 115 sets an initial state of each resource and executes a simulation, using the current resource position information and dispatch availability information included in the resource data, and assigns the evaluation value to each of the plurality of allocation plans on the basis of the result of the simulation. For example, the initial state reflecting the current position and the current dispatch availability is set for each vehicle, and the simulation is started. As a result, the simulation that reflects the current situation can be performed rather than randomly determining the initial state, and it is expected that a more appropriate evaluation value can be calculated.

Furthermore, the allocation evaluation unit 115 executes a simulation of a case of moving each resource to the latitude and longitude of the destination, using the current resource position information and dispatch availability information included in the resource data, and assigns the evaluation value to each of the plurality of allocation plans on the basis of the result of the simulation. In this case, it is possible to evaluate good or bad of movement in consideration of a change in a cover range by the dispatch of each squad.

In the above simulation, for example, by considering a near future such as one hour ahead, it is possible to obtain an effect of performing an evaluation by focusing on a time zone having a large influence of moving a vehicle, or expecting that the time required for calculation is shorter than that in a case of performing a simulation of one day, or the like, for example. In addition, it is expected to obtain an appropriate evaluation value only by the simulation of the near future by determining the initial state of the vehicle using the latest information.

An example of the “data to be used for evaluation value calculation” illustrated in FIG. 18 includes the time taken from dispatch to return of the vehicle, as described above. In addition, the number of evaluation values to be assigned is not limited to one, and for example, it is conceivable to assign the number of cases where the site arrival distance is equal to or more than a threshold as the evaluation value. To obtain a more accurate evaluation value, the simulation may be performed a plurality of times, and an evaluation value calculated from the results of the plurality of times may be assigned to each evaluation item. In the case of performing the simulation a plurality of times, it is desirable to acquire main samples as many as the number of times of simulation as illustrated in FIG. 18 described above. Note that the calculation time can be adjusted by adjusting the number of simulations.

Note that the simulation can be used not only for assigning the evaluation value in the allocation evaluation unit 115 but also for determining whether to perform calculation for calculating the allocation plan by performing the simulation for a current situation and calculating the evaluation value before creating the allocation plan. For example, the number of cases where the site arrival distance is equal to or larger than the threshold may also be assigned as the evaluation value, and the allocation plan may be calculated only in a case where the number of cases exceeds a certain constant.

As the above effect, in actual operation, since the number of times of performing an operation of obtaining the allocation plan can be reduced, reduction in a burden on an operator or the like is expected. Meanwhile, from the standpoint of an analyst, since the number of times of evaluating the allocation plan can be reduced, suppression of the calculation time of the entire simulation throughout a period is expected.

The allocation plan selection unit 116 selects an effective allocation plan from the plurality of allocation plans on the basis of the evaluation value assigned to each of the plurality of allocation plans by the allocation evaluation unit 115. Specifically, for example, it is possible to determine the moving target vehicle and its destination by selecting one with the highest evaluation value from the evaluation results illustrated in FIG. 23. In a case where there is a plurality of evaluation values, for example, it is possible to select one with a high evaluation value 2 when evaluation values 1 are the same, or select one with the highest evaluation value 1 from among ones with the evaluation values 2 equal to or more than a threshold. In addition, it is possible to calculate how the evaluation value changes by moving the vehicle by calculating the evaluation value of each evaluation item for a situation before moving the vehicle (current situation), and it is possible to perform processing of not adopting even one with the highest evaluation value in the allocation plan list when the evaluation value is lower than the current situation.

Here, the sample output unit 112 may further output, as an auxiliary sample, the future event occurrence data that is likely to occur under a condition similar to the predetermined condition on the basis of the latest event occurrence data. The auxiliary sample is expressed as, as described above, a pseudo occurrence data row generated in a pseudo manner in accordance with the event occurrence frequency that is obtained in each certain area on the basis of the data row that has actually occurred under the similar condition. Further, the auxiliary sample may also be expressed as a pseudo occurrence data row generated in a pseudo manner in accordance with the random variable of the event occurrence probability that is obtained on the basis of the data row that has actually occurred under the similar condition.

In this case, the allocation plan creation unit 114 creates a plurality of allocation plans in real time using the resource data, the main sample, and the auxiliary sample. Then, when the main sample and the auxiliary sample are applied to each of the plurality of allocation plans created by the allocation plan creation unit 114, the allocation evaluation unit 115 assigns the evaluation value to each of the plurality of allocation plans using the resource data. Note that, since the auxiliary sample is not essential, whether to use the auxiliary sample is arbitrary.

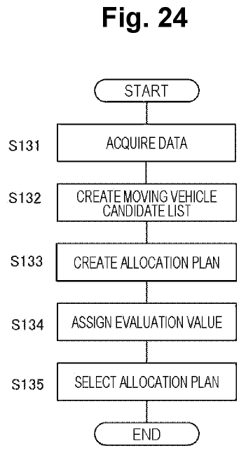

FIG. 24 is a flowchart illustrating an example of a flow of processing by an allocation search program according to the second embodiment. The processing by the allocation search program is implemented by the CPU 11 of the allocation search device 10A writing the allocation search program stored in the ROM 12 or the storage 14 to the RAM 13 and executing the allocation search program.

In step S131 of FIG. 24, the CPU 11 acquires, as an example, the resource data illustrated in FIG. 17, the main sample illustrated in FIG. 18, the fire station data illustrated in FIG. 19, and the correspondence data between an ambulance and a fire station illustrated in FIG. 20.

In step S132, the CPU 11 creates the moving vehicle candidate list illustrated in FIG. 21 as an example according to a real-time situation using the various data acquired in step S131. In the moving vehicle candidate list, as described above, one vehicle may be designated or a plurality of vehicles may be designated as the moving target vehicle. Furthermore, it is assumed that the resource data obtained in real time is reflected such as the moving target vehicle being limited to vehicles that are dispatchable and stand by at the fire stations, limited to vehicles whose number of movements is equal to or less than a threshold, or the like.

In step S133, the CPU 11 calculates the destination of each moving vehicle candidate registered in the moving vehicle candidate list created in step S132 using an arbitrary calculation method, and as an example, creates the above-described allocation plan list illustrated in FIG. 22. Note that the destination referred to here is not limited to a fire station, and includes any point other than a fire station.

In step S134, the CPU 11 assigns the evaluation value as illustrated in FIG. 23 above, as an example, using the resource data, in the case where the main sample is applied to or in the case where the main sample and the auxiliary sample are applied to each allocation plan registered in the allocation plan list created in step S133. As a method of calculating the evaluation value, specifically, for example, there is a method of reflecting the current position information and dispatch availability information of each vehicle obtained from the resource data illustrated in FIG. 17 and performing a simulation for each moving vehicle candidate in a case of moving the moving target vehicle to the latitude and longitude of the destination.

In step S135, the CPU 11 selects an effective allocation plan from the plurality of allocation plans on the basis of the evaluation value assigned to each of the plurality of allocation plans in step S134, and terminates the series of processing according to the present allocation search program. Specifically, as an example, it is possible to determine the moving target vehicle and its destination by selecting one with the highest evaluation value from the above-described evaluation results illustrated in FIG. 23.

Here, as described above, the allocation search device 10A according to the present embodiment includes one sample output unit 112 and one allocation evaluation unit 115. The sample output unit 112 can take any of two configurations of a configuration for outputting only the main sample and a configuration for outputting the main sample and the auxiliary sample. Note that the evaluation criteria by the allocation evaluation unit 115 may be the same or different between the main sample and the auxiliary sample.

### Modification of Second Embodiment

In the above embodiment, a mode including an arbitrary point other than fire stations as the destination has been described, but in the following modification, a mode in which the destination is limited to a fire station will be described. That is, the above-described (2) dynamic allocation in fire stations, that is, a mode of creating an allocation plan without using the main sample will be described.

In this case, the allocation plan creation unit 114 creates a plurality of allocation plans of resources corresponding to an occurring event, using the resource data. Then, the allocation evaluation unit 115 assigns the evaluation value to each of the plurality of allocation plans using the resource data. Note that the allocation evaluation unit 115 may assign the evaluation value further using the main sample output from the sample output unit 112 in addition to the resource data. Examples of such a method of assigning the evaluation value include a method using a simulation.

In the present modification, different processing will be described with reference to the above-described flowchart illustrated in FIG. 24.

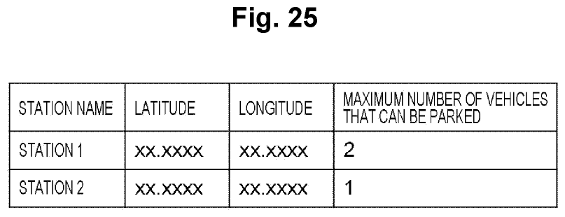

As the fire station data acquired in step S131, for example, it is desirable to adopt the fire station data illustrated in FIG. 25.

FIG. 25 is a table illustrating another example of the fire station data according to the present embodiment.

The fire station data illustrated in FIG. 25 includes a station name, latitude and longitude representing a place, and the maximum number of vehicles that can be parked, regarding a fire station. Note that if the maximum number of vehicles that can be parked is not considered, the above-described fire station data illustrated in FIG. 19 may be adopted.

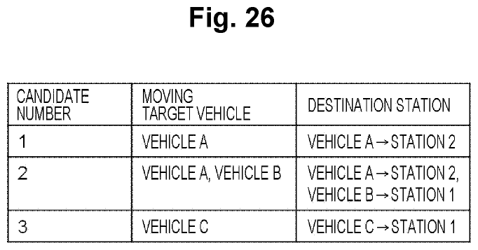

In step S133, the moving vehicle candidate list illustrated in FIG. 26 is created from the above-described moving vehicle candidate list illustrated in FIG. 21.

FIG. 26 is a table illustrating another example of the moving vehicle candidate list according to the present embodiment.

In the moving vehicle candidate list illustrated in FIG. 26, for example, a case where one vehicle is basically moved to any fire station is set as one candidate, and all patterns thereof are obtained, so that a list with the fire station as the destination can be obtained. In this case, the number of rows in the list with the destination fire station is larger than the number of rows in the original list as illustrated in FIG. 21. In addition, candidates can be narrowed down by the following processing.
(a) Exclude the fire station to which a host vehicle belongs.
(b) Consider a parking space of each fire station. A fire station to which a vehicle can be moved (that is, a parkable fire station) is extracted according to the current position of each vehicle, the dispatch availability information, and the maximum number of vehicles that can be parked. At this time, it may be thought that the parking space is used in a case where a vehicle is actually in the fire station as the current position, or it may be thought that the parking space of the fire station ahead is used in a case where a vehicle is heading to the fire station. Note that, in a case where the parking space is not considered, this processing may not be performed.
(c) Set distance limits. For example, a method of extracting a fire station at the distance from the fire station to which the vehicle belongs being equal to or less than a threshold, or a method of extracting a fire station with a total of the distance from the current position of the vehicle to the destination fire station, and the distance from the destination fire station to the fire station to which the vehicle belongs being equal to or less than a threshold is conceivable. This processing can exclude fire stations that are too far away. Note that, in a case where the distance limit is not set, this processing may not be performed.

In step S133, the latitude and longitude of each fire station are assigned to each moving vehicle candidate, and the allocation plan list as illustrated in FIG. 22 is obtained as an example.

After the allocation plan list illustrated in FIG. 22 is obtained, the processing is similar to the above-described mode including an arbitrary point other than fire stations. Note that, for discrete standby points other than fire station, it is considered that the processing can be similarly handled by using data regarding discrete standby points instead of using the data regarding fire stations in step S133.

As described above, according to the present embodiment, the destination of the resource can be calculated in real time using the latest data.

Note that allocation search processing that is executed by the CPU reading software (program) in the above embodiment may be executed by various processors other than the CPU. Examples of the processors in this case include a programmable logic device (PLD) whose circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). Further, the allocation search processing may be executed by one of the various processors or may be executed by a combination of two or more processors of the same type or different types (e.g. a combination of a plurality of FPGAS or a combination of a CPU and an FPGA). More specifically, a hardware structure of the various processors is an electric circuit in which circuit elements such as semiconductor elements are combined.

Further, in the above embodiments, the aspect in which the allocation search program is stored (installed) in advance in the storage has been described, but the embodiments are not limited thereto. The program may be provided by being stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

Regarding the above embodiments, the following supplementary notes are further disclosed.

### (Supplement 1)

An allocation search device configured to include:
a memory; and
at least one processor connected to the memory, in which
the processor is further configured to:
acquire resource data including a latest resource position and dispatch availability;
create a plurality of allocation plans of a resource corresponding to an occurring event, using the resource data;
assign an evaluation value to each of the plurality of allocation plans, using the resource data; and
select an effective allocation plan from the plurality of allocation plans on a basis of the evaluation value assigned to each of the plurality of allocation plans.

### (Supplement 2)

A non-transitory storage medium storing a program executable by a computer to execute allocation search processing including:
acquiring resource data including a latest resource position and dispatch availability;
creating a plurality of allocation plans of a resource corresponding to an occurring event, using the resource data;
assigning an evaluation value to each of the plurality of allocation plans, using the resource data; and
selecting an effective allocation plan from the plurality of allocation plans on a basis of the evaluation value assigned to each of the plurality of allocation plans.

### REFERENCE SIGNS LIST

10, 10A Allocation search device
11 CPU
12 ROM
13 RAM
14 Storage
15 Input unit
16 Display unit
17 Communication I/F
18 Bus
101 First sample output unit
101A First main sample output unit
101B First auxiliary sample output unit
102 Allocation plan creation unit
103 First allocation evaluation unit
104 Second sample output unit
104A Second main sample output unit
104B Second auxiliary sample output unit
105 Second allocation evaluation unit
106 Result output unit
111 Resource data acquisition unit
112 Sample output unit
113 Various data acquisition unit
114 Allocation plan creation unit
115 Allocation evaluation unit
116 Allocation plan selection unit
141 Ambulance data
142 Fire station data
143 Past event occurrence data
144 Effective allocation plan
145 Latest event occurrence data

1. An allocation search device comprising:
a resource data acquisition unit configured to acquire resource data including a latest resource position and dispatch availability;
an allocation plan creation unit configured to create a plurality of allocation plans of a resource corresponding to an occurring event, using the resource data;
an allocation evaluation unit configured to assign an evaluation value to each of the plurality of allocation plans, using the resource data; and
an allocation plan selection unit configured to select an effective allocation plan from the plurality of allocation plans on a basis of the evaluation value assigned to each of the plurality of allocation plans.

2. The allocation search device according to claim 1, further comprising:
a sample output unit configured to output, as a main sample, future event occurrence data that is likely to occur under a predetermined condition on a basis of latest event occurrence data, wherein
the allocation plan creation unit creates the plurality of allocation plans, using the resource data and the main sample, and
the allocation evaluation unit assigns the evaluation value to each of the plurality of allocation plans, using the resource data, in a case where the main sample is applied to each of the plurality of allocation plans.

3. The allocation search device according to claim 1, wherein
the allocation evaluation unit executes a simulation of a case of moving each resource to latitude and longitude of a destination, using current resource position information and dispatch availability information included in the resource data, and assigns the evaluation value to each of the plurality of allocation plans on a basis of a result of the simulation.

4. The allocation search device according to claim 1, wherein
the allocation evaluation unit sets an initial state of each resource and executes a simulation, using current resource position information and dispatch availability information included in the resource data, and assigns the evaluation value to each of the plurality of allocation plans on a basis of a result of the simulation.

5. The allocation search device according to claim 2, wherein
the main sample is expressed as a pseudo occurrence data row generated in a pseudo manner in accordance with an event occurrence frequency that is obtained for each certain area from a data row that has actually occurred under the predetermined condition.

6. The allocation search device according to claim 2, wherein
the main sample is expressed as a pseudo occurrence data row generated in a pseudo manner in accordance with a random variable of an event occurrence probability that is obtained as the random variable from a data row that has actually occurred under the predetermined condition.

7. An allocation search method comprising:
acquiring resource data including a latest resource position and dispatch availability;
creating a plurality of allocation plans of a resource corresponding to an occurring event, using the resource data;
assigning an evaluation value to each of the plurality of allocation plans, using the resource data; and
selecting an effective allocation plan from the plurality of allocation plans on a basis of the evaluation value assigned to each of the plurality of allocation plans.

8. A computer-readable non-transitory recording medium storing computer-executable program instructions that when executed by a processor cause a computer to execute an allocation search program for causing a computer to execute:
acquiring resource data including a latest resource position and dispatch availability;
creating a plurality of allocation plans of a resource corresponding to an occurring event, using the resource data;
assigning an evaluation value to each of the plurality of allocation plans, using the resource data; and
selecting an effective allocation plan from the plurality of allocation plans on a basis of the evaluation value assigned to each of the plurality of allocation plans.

9. The allocation search method according to claim 7, further comprising:
output, as a main sample, future event occurrence data that is likely to occur under a predetermined condition on a basis of latest event occurrence data, wherein
creating the plurality of allocation plans, using the resource data and the main sample, and
assigning the evaluation value to each of the plurality of allocation plans, using the resource data, in a case where the main sample is applied to each of the plurality of allocation plans.

10. The allocation search method according to claim 7, wherein
executing a simulation of a case of moving each resource to latitude and longitude of a destination, using current resource position information and dispatch availability information included in the resource data, and assigns the evaluation value to each of the plurality of allocation plans on a basis of a result of the simulation.

11. The allocation search method according to claim 7, wherein
setting an initial state of each resource and executes a simulation, using current resource position information and dispatch availability information included in the resource data, and assigns the evaluation value to each of the plurality of allocation plans on a basis of a result of the simulation.

12. The allocation search method according to claim 7, wherein
the main sample is expressed as a pseudo occurrence data row generated in a pseudo manner in accordance with an event occurrence frequency that is obtained for each certain area from a data row that has actually occurred under the predetermined condition.

13. The allocation search method according to claim 7, wherein
the main sample is expressed as a pseudo occurrence data row generated in a pseudo manner in accordance with a random variable of an event occurrence probability that is obtained as the random variable from a data row that has actually occurred under the predetermined condition.

14. The computer-readable non-transitory recording medium according to claim 8 wherein the allocation search program method further comprises:
output, as a main sample, future event occurrence data that is likely to occur under a predetermined condition on a basis of latest event occurrence data, wherein
creating the plurality of allocation plans, using the resource data and the main sample, and
assigning the evaluation value to each of the plurality of allocation plans, using the resource data, in a case where the main sample is applied to each of the plurality of allocation plans.

15. The computer-readable non-transitory recording medium according to claim 8 wherein the allocation search program method further comprises:
executing a simulation of a case of moving each resource to latitude and longitude of a destination, using current resource position information and dispatch availability information included in the resource data, and assigns the evaluation value to each of the plurality of allocation plans on a basis of a result of the simulation.

16. The computer-readable non-transitory recording medium according to claim 8 wherein the allocation search program method further comprises:
setting an initial state of each resource and executes a simulation, using current resource position information and dispatch availability information included in the resource data, and assigns the evaluation value to each of the plurality of allocation plans on a basis of a result of the simulation.

17. The computer-readable non-transitory recording medium according to claim 8 wherein the allocation search program method further comprises:
the main sample is expressed as a pseudo occurrence data row generated in a pseudo manner in accordance with an event occurrence frequency that is obtained for each certain area from a data row that has actually occurred under the predetermined condition.

18. The computer-readable non-transitory recording medium according to claim 8 wherein the allocation search program method further comprises:
the main sample is expressed as a pseudo occurrence data row generated in a pseudo manner in accordance with a random variable of an event occurrence probability that is obtained as the random variable from a data row that has actually occurred under the predetermined condition.

19. The allocation search device according to claim 1, wherein a layout plan that meets a plurality of requirements is obtained based on determination of resource movement.
